(19) United States
(12) Patent Application Publication
(10) Pub. No.: US 2004/0090769 A1
(43) Pub. Date: May 13, 2004

(54) Bicycle helmet safety lights

(76) Inventor: William Allen Milton, Yakutat, AK (US)

Correspondence Address: WILLIAM A. MILTON, P.O. BOX 3, YAKUTAT, AK, 99689, US

(21) Appl. No.: 10/391,072

(22) Filed: Jan. 26, 2004

Related U.S. Application Data
(60) Provisional application No. 60/365,626, filed on Mar. 18, 2002.

(51) Int. Cl. F21V 21/084

(52) U.S. Cl. 362/105

(57) ABSTRACT

Bicycle Helmet Safety Lights are small lights built into the outer rim of the helmet.

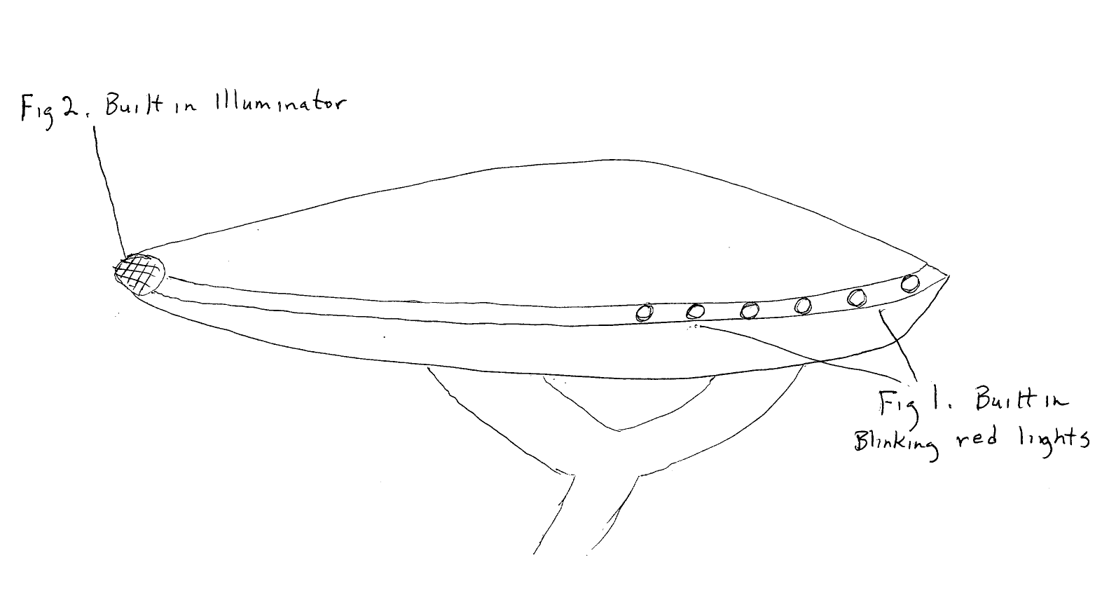

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISK APPENDIX

NOT APPLICABLE

### BACKGROUND OF THE INVENTION

My idea/invention pertains to lights added to and “Built In” to existing Manufactured Bicycle Helmets. Existing Manufactured Bicycle Helmets do not at this time utilize lights as a safety factor.

### BRIEF SUMMARY OF INVENTION

Bicycle Helmet Safety lights will greatly enhance the safety of the user by providing greater “visibility” and notice ability of the user.

### BRIEF DESCRIPTION OF DRAWING

The drawing shows the “lights” as they would appear on the outer rim of the bicycle helmet.

### DETAILED DESCRIPTION OF THE INVENTION

Bicycle Helmet Safety Lights will consist of eight small lights of “LED” technology “built in” to the outer rear rim of the helmet and extending half-way around on either side of the helmet. These lights will be connected by wire to a switch and battery pads

1. What I claim as my invention is built in lights on bicycle safety helmets.
